(19) United States
(12) Patent Application Publication
(10) Pub. No.: US 2015/0178960 A1
(43) Pub. Date: Jun. 25, 2015

(54) X-RAY TOMOGRAPHY APPARATUS AND X-RAY TOMOGRAPHY IMAGING METHOD

(71) Applicant: CANON KABUSHIKI KAISHA, Tokyo (JP)

(72) Inventor: Takeshi Kondoh, Kawasaki-shi (JP)

(21) Appl. No.: 14/571,962

(22) Filed: Dec. 16, 2014

(30) Foreign Application Priority Data
Dec. 20, 2013 (JP) 2013-263596

(51) Int. Cl. G06T 11/00; G01N 23/04

(52) U.S. Cl. CPC G06T 11/008; G01N 23/046

(57) ABSTRACT

In an X-ray tomography apparatus, a tomographic image of a subject is acquired using a subject projection image detected by a detector in a state in which the subject is in a field of view of the detector and a plurality of reference projection images detected by the detector in a state in which the subject is not in the field of view of the detector. The detector detects the subject projection image and the reference projection image at a plurality of projection angles, and the operation unit is configured to acquire a background image using a plurality of reference projection images, acquire a projection image of subject information using the subject projection image and the background image for each of the projection angles, and acquire tomographic image of the subject information from the projection image of the subject information for each of the projection angles.

### BACKGROUND OF THE INVENTION

1. Field of the Invention

The present invention relates to a X-ray tomography apparatus and a X-ray tomography imaging method.

2. Description of the Related Art

In recent years, it has been known to obtain a tomographic image including absorption information and/or phase information of a subject using an X-ray tomography apparatus including an X-ray source, a detector, a diffracting grating, and the like (International Publication No. WO2004/058070).

In the X-ray tomography apparatus, it is common to correct an influence of an irradiation unevenness of an X-ray source, a sensitivity unevenness of a detector, or the like in a subject projection image obtained by taking an image of a subject by using a reference projection image obtained by taking an image without including the subject. Hereinafter, the image taken without including the subject will also be referred to as a background image.

In the present specification, the correction described above is referred to as a background correction. In a case where a reference image and a subject image have the same background, the background correction may be performed correctly. However, in a case where a reference image and a subject image have different backgrounds, there is a possibility that the background correction is not performed correctly. In the present specification, a projection image acquired in a state including no subject is referred to a subject projection image, and a projection image acquired in a state including a subject is referred to a reference projection image.

An X-ray intensity distribution, a sensitivity characteristic of the detector, a position of the diffracting grating, and the like may change with passage of time, and thus there is a possibility that the background changes with passage of time.

Therefore, in a case where the reference image is acquired only once, the background may change during a tomographic image process which may need a long time to take a plurality of projection images. Therefore, in this case, there is a possibility that a projection image or a tomographic image obtained by performing the background correction include an artifact caused by incorrectness of the background correction.

In a technique disclosed in European Radiology, 23,381 (2013), to handle the change in the background with passage of time, a total of 1,119 subject projection images are acquired during each tomographic image process, and a reference projection image is acquired every 100 subject projection images thereby reducing an artifact.

### SUMMARY OF THE INVENTION

According to an aspect of the invention, an X-ray tomography apparatus includes a detector configured to detect an X-ray passing though a subject, a moving unit configured to move at least one of the subject and the detector, and an operation unit configured to acquire a tomographic image of the subject using a subject projection image detected by the detector in a state in which the subject is in a field of view of the detector and a plurality of reference projection images detected by the detector in a state in which the subject is not in the field of view of the detector, wherein the detector is configured to detect the subject projection image and the reference projection image at a plurality of projection angles, and the operation unit is configured to acquire a background image using a plurality of reference projection images, acquire a projection image of subject information using the subject projection image and the background image for each of the projection angles, and acquire tomographic image of the subject information from the projection image of the subject information for each of the projection angles.

Further features of the present invention will become apparent from the following description of exemplary embodiments with reference to the attached drawings.

### BRIEF DESCRIPTION OF THE DRAWINGS

FIG. 1 is a diagram schematically illustrating an X-ray tomography apparatus according to an embodiment.

FIG. 2 is a flow chart illustrating an imaging process according to an embodiment.

FIG. 3A is a diagram illustrating a sinogram acquired from a subject projection image obtained by performing a background correction using a background image in a first example.

FIG. 3B is a diagram illustrating a phase tomography image acquired from the subject projection image obtained by performing the background correction using the background image in the first example.

FIG. 4 A is a diagram illustrating a sinogram acquired from a subject projection image obtained by performing a background correction using a background image in a second example.

FIG. 4B is a diagram illustrating a phase tomography image acquired from the subject projection image obtained by performing the background correction using the background image in the second example.

FIG. 5A is a diagram illustrating a sinogram acquired from a subject projection image obtained by performing a background correction using a background image in a third example.

FIG. 5B is a diagram illustrating a phase tomography image acquired from the subject projection image obtained by performing the background correction using the background image in the third example.

FIG. 6A is a diagram illustrating a sinogram acquired from a subject projection image obtained by performing a background correction using a background image in a fourth example.

FIG. 6B is a diagram illustrating a phase tomography image acquired from the subject projection image obtained by performing the background correction using the background image in the fourth example.

FIG. 7 is a diagram illustrating a phase tomography image acquired a fifth example.

FIG. 8A is a diagram illustrating a sinogram acquired from a subject projection image obtained by performing a background correction using a background image according to a known method.

FIG. 8B is a diagram illustrating a phase tomography image acquired from the subject projection image obtained by performing the background correction using the background image according to the known method.

FIG. 9A is a diagram illustrating a sinogram acquired from a subject projection image obtained by performing a background correction in a comparative example.

FIG. 9B is a diagram illustrating a phase tomography image acquired from the subject projection image obtained by performing the background correction in the comparative example.

### DESCRIPTION OF THE EMBODIMENTS

Although it is possible to reduce an artifact by acquiring a plurality of reference projection images during a tomography imaging process as described, for example, in European Radiology, 23,381 (2013). However, the reduction is not always sufficient.

Besides, embodiments of the invention are also adapted to handle a further situation in which statistical noise included in a projection image may cause an artifact to appear in a tomographic image obtained by performing a background correction if a reference projection image does not have high enough a signal-to-noise ratio.

In an embodiment, one background image is acquired using a plurality of reference projection images, and, using this background image, a projection image of subject information is acquired. Note that in known techniques, only one reference projection image is used to acquire one projection image of subject information. In the present embodiment, use of plurality of reference projection images to acquire a background image makes it possible to more effectively reduce an artifact appearing in a projection image of subject information than is achieved by the known techniques. Furthermore, because a tomographic image is acquired from a projection image of subject information including a less artifact than an artifact according to the known techniques, it is also possible to reduce an artifact in the tomographic image of subject information.

In the present specification, a projection image representing information associated with a subject acquired using a subject projection image and a reference projection image is referred to as a background-corrected subject projection image. Examples of the information associated with the subject are, for example, an absorption, a scattering, a phase shift, and the like of an X-ray by the subject. The projection image representing the absorption of the X-ray by the subject is referred to as an absorption projection image, the projection image representing the scattering of the X-ray by the subject is referred to as a scattering projection image, and the projection image representing the phase shift of the X-ray by the subject is referred to as a phase projection image. Note that in the present specification, each type of projection image and each type of tomographic image do not necessarily need to be in the form of images but each image may be given in the form of information representing that image. For example, an absorption projection image of a subject may be absorption information of the subject at a plurality of coordinates (absorption information of the subject at (x1, y1), (absorption information of the subject at (x2, y2), and so on). Even in a case where the X-ray tomography apparatus does not have a function of displaying a projection image, if information associated with the projection image is used in acquiring a tomographic image, it is regarded that the projection image is acquired.

In the present embodiment, a X-ray tomography apparatus using by way of example a Talbot-Lau interferometer and an X-ray tomography imaging method are described below. In particular, when an optical element that absorbs a X-ray, such as a grating, is used, it tends to need a longer time to take an image, and thus the present embodiment is particularly useful for an X-ray tomography apparatus including an optical element that absorbs an X-ray. In the present specification, the X-ray imaging apparatus refers to an apparatus configured to acquire information associated with a subject by acquiring an X-ray intensity distribution.

An X-ray imaging apparatus using Talbot interference is described briefly below. A more detailed description thereof may be found, for example, in Optics Express, 36,3551 (2011).

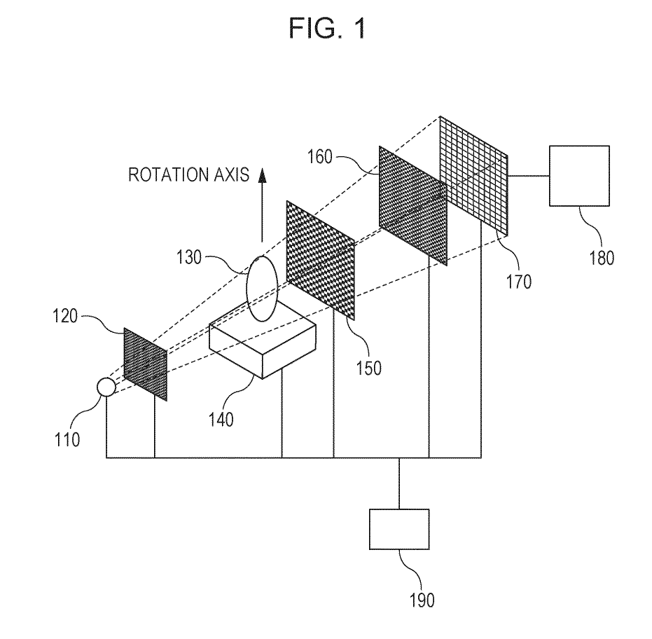

FIG. 1 is a diagram schematically illustrating the X-ray tomography apparatus according to the present embodiment.

The X-ray tomography apparatus according to the present embodiment includes, as illustrated in FIG. 1, an X-ray source 110, a source grating 120 that is a two-dimensional splitting grating configured to split a X-ray emitted from the X-ray source, a diffracting grating 150 that is a two-dimensional diffracting grating configured to diffract the X-ray from the X-ray source, and an absorption grating 160 that is a two-dimensional absorption grating configured to absorb a part of the X-ray. The X-ray tomography apparatus further includes a detector 170 configured to detect a X-ray passing through the absorption grating, an operation unit 180 configured to perform a calculation on a result of a detection made by the detector 170, and a moving unit configured to move at least one of the subject 130 and the detector 170. The moving unit includes a rotation unit 140 configured to turn the subject 130 about a rotation axis and a translation unit 190 configured to translate the subject 130.

In a case where the detector is capable of directly detecting an interference pattern formed by the diffracting grating, the absorption grating may not be used. Furthermore, in a case where the X-ray source has a small focal spot size, the source grating may not be used.

A further detailed description of each unit is given below.

The X-ray emitted from the X-ray source 110 is split by the source grating 120. After passing though the source grating 120, the X-ray falls on the subject 130 put on a subject stage.

The rotation unit 140 is capable of turning the subject about the rotation axis. This makes it possible to take an image of a subject from a plurality of angles. By irradiating the subject with the X-ray from a plurality of angles, it is possible to obtain a tomographic image.

The translation unit 190 is capable of translating the subject to an area outside the field of view of the detector. This makes it possible to take an image in a state in which the field of view does not include the subject, that is, it is possible to acquire a reference projection image. In a case where it is necessary to consider minimization of exposure of the subject to the X-ray, it may be desirable not to irradiate the subject with the X-ray during the process of acquiring the reference projection image.

The rotation unit may be realized, for example, by a subject stage having an actuator or the like and being capable of rotatable. Instead of turning the subject by the rotation unit 140, the actuator may turn the X-ray source 110, the detector 170, and three gratings 120, 150, and 160 around the subject as with a common medical computed tomography (CT) imaging apparatus. In this case, it may be allowed to use a gantry to which the X-ray source 110, the detector 170, and the three gratings 120, 150, and 160 are fixed. Alternatively, the X-ray source 110, the detector 170, and the three gratings 120, 150, and 160 may be disposed along a circumference around the subject such that it is possible to take an image of the subject from a plurality of angles without using the rotation unit. In this case, the rotation unit may be unnecessary. On the other hand, the essential function necessary for the translation unit 190 is to move the subject until the subject is off the field of view of the detector. That is, what is necessary is to translate the relative position between the subject and the imaging area. For example, the translation unit may be realized such that the X-ray source 110, the detector 170, and the three gratings 120, 150, and 160 are translated using a gantry. In the case where the gantry is used, the gantry may function as both the rotation unit and the translation unit. In this case, by performing helical scanning, it is possible to simultaneously perform the translation and the rotation. The diffracting grating 150 diffracts the X-ray passed through the subject 130.

The diffracting grating 150 includes phase reference parts and phase shifting parts that are periodically arranged such that the phase of the X-ray is changed periodically.

When the X-ray passed through the subject 130 is diffracted by the diffracting grating 150, an interference pattern is formed at a particular distance called a Talbot distance.

Note that in the present embodiment, the periodic pattern does not necessarily need to have a particular constant period.

The absorption grating 160 is disposed at a place apart from the diffracting grating 150 by the Talbot distance such that the interference pattern is formed on the absorption grating. In the absorption grating 160, X-ray absorption parts and X-ray passage parts are periodically arranged.

The period of the arrangement of the absorption parts and the passing parts is slightly different from the period of the interference pattern formed on the absorption grating, and thus a moire pattern is formed by the X-ray passed through the absorption grating 160.

In the present embodiment, the moire pattern formed by the diffracting grating 150 and the absorption grating 160 is detected, and information associated with the subject 130 is acquired from the moire pattern.

The detector 170 includes pixels capable of detecting intensity of the X-ray thereby detecting the moire pattern formed by the X-ray passed through the absorption grating 160.

Based on a result of the detection made by the detector 170, the operation unit 180 acquires information associated with the subject 130 in terms of the absorption, the phase, and the scatter (a projection image of subject information). In the present specification, a Fourier transform method (see, for example, Journal of the Optical Society of America, 72,156) is used to acquire the information of the projection image of subject information. However, there is no particular restriction on the method of acquiring subject information, and other methods such as a phase shifting method or a combination of the phase shifting method and the Fourier transform method or the like may be employed. When the information associated with the subject is acquired, a background image is acquired using a plurality of reference projection images. A projection image of subject information is then acquired using a detection result obtained as a result of taking the image of the subject (a subject projection image) and the background image. In a case where the Talbot interferometer is used to acquire the projection image of subject information, it is possible to acquire, as the projection image of subject information, an absorption projection image, a phase projection image, and a scattering projection image. It is possible to obtain these projection images from a moire pattern by making a calculation. Note that it does not necessarily need to acquire all above-described three types of projection images of subject information, but it may be sufficient to acquire at least one of the three types projection images of subject information. The operation unit 180 reconstructs a tomographic image from the plurality of projection images of subject information.

Hereinafter, tomographic images reconstructed from an absorption projection image, a phase projection image, and a scattering projection image are respectively referred to as an absorption tomography image, a phase tomography image, and a scattering tomography image. In the present specification, a filtered back projection method is used as an image reproduction method. However, there is no particular restriction on the image reproduction method. In the present embodiment, when a plurality of projection images are each acquired, a plurality of reference projection images are used to reduce artifact in each projection image. Therefore, it is possible to obtain beneficial effects of the present embodiment even when no tomographic image is acquired.

Next, an imaging condition using the X-ray tomography apparatus described above is discussed. In the X-ray tomography apparatus according to the present embodiment, after an image of the subject is taken at one or more projection angles, the subject is moved off the field of view of the detector and a reference projection image is acquired in a state in which the subject is off the field of view of the detector. After the reference projection image is acquired, the subject is again moved into the field of view of the detector and an image of the subject is taken at an angle different from the projection angle used for the previous image of the subject taken before acquiring the reference projection image. That is, the subject is moved into and off the field of view of the detector using the moving mechanism 190, and the projection angle is changed using the rotating mechanism 140. Next, a specific example of taking an image using the X-ray tomography apparatus according to the present embodiment is described below. In this example, a kidney of a mouse fixed in formalin was put in an Eppendorf tube and was employed as a subject.

The Eppendorf tube employed as the subject was sunk in a plastic container filled with water such that only the Eppendorf tube and the content was allowed to rotate.

An image was taken each time the subject was turned about the rotation axis by 0.5°, and a total of 360 subject projection images were acquired. Hereinafter, the respective subject projection images will be denoted by S₁, S₂, . . . , S₃₆₀. In the process, each time the subject was turned by 30°, the subject was moved off the field of view of the detector and an image was taken thereby acquiring a total of 7 reference projection images.

Hereinafter, the respective reference projection images will be denoted by R₁, R₂, . . . , R₇. That is, R₁, R₂, . . . , R₆ were respectively acquired immediately before S₁, S₆₁, S₁₂₁, S₁₈₁, S₂₄₁, and S₃₀₁ were acquired, and R7 was acquired immediately after S₃₆₀ was acquired.

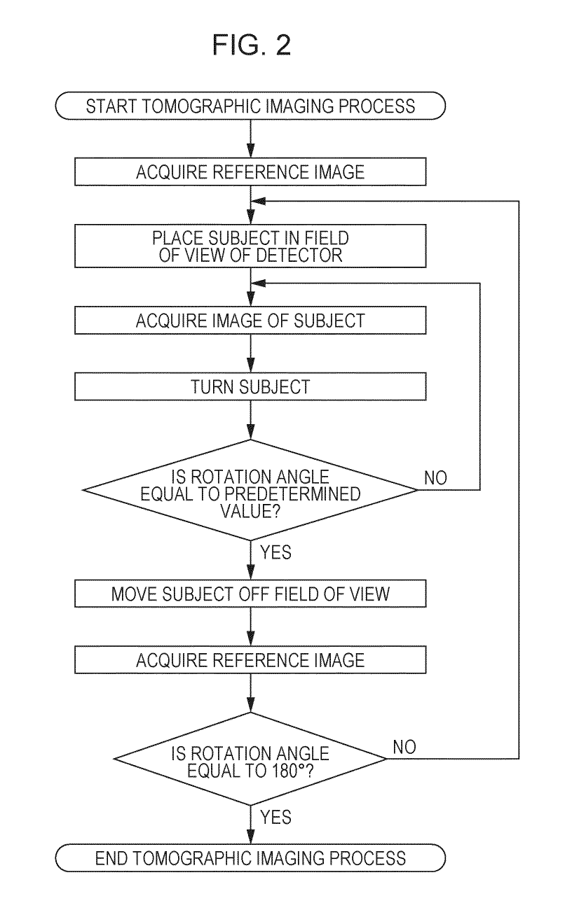

FIG. 2 illustrates a flow of the employed image taking process.

In the following, a specific example is described to illustrate how the subject projection images (S₁, S₂, . . . , S₃₆₀) and the reference projection images (R₁, R₂, . . . , R₇) obtained by taking images under the condition described above are used to calculate a background image from reference projection images and make a background correction using the calculated background image. Hereinafter, the background image used in correcting the background of the subject image Sₙ (n=1, 2, . . . , 360) is denoted by Bₙ (n=1, 2, . . . , 360). Note that the phase projection image was employed as the projection image of subject information.

### COMPARATIVE EXAMPLES

### First Comparative Example

Before describing the examples, comparative examples are described to show how the artifact is reduced compared with these comparative examples. In a first comparative example, one reference projection image was acquired each time one subject projection image was acquired, that is, subject projection images and reference projection images were acquired alternately and a subject tomography image was acquired from the acquired 360 subject projection images and 360 reference projection images. In this comparative example, one background-corrected projection image was acquired using corresponding one subject projection image and one reference projection image acquired immediately after this subject projection image.

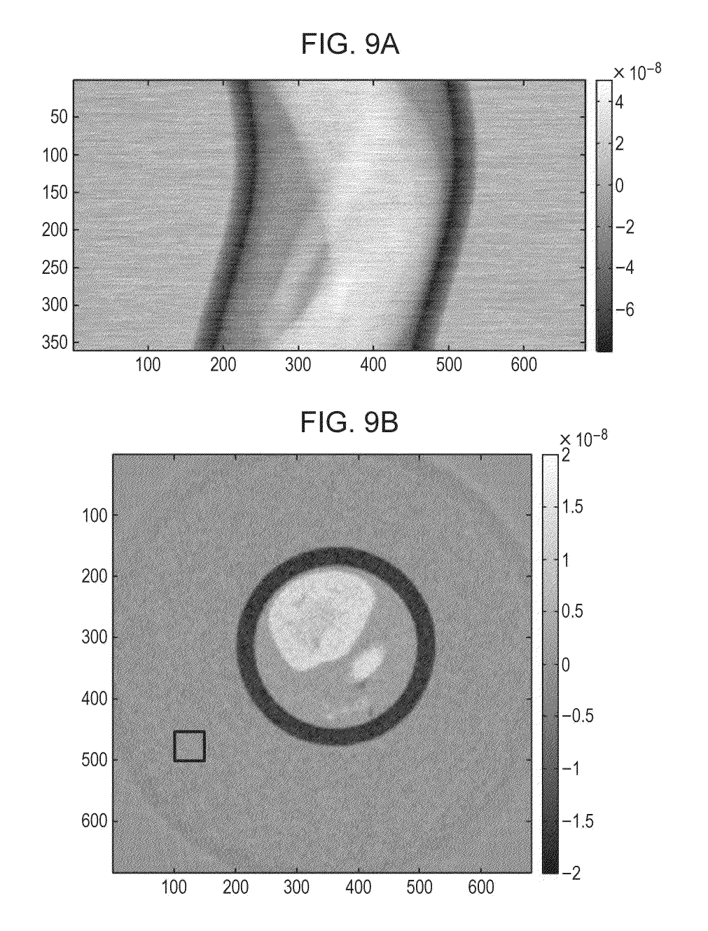

FIG. 9A and FIG. 9B respectively illustrate a sinogram and a phase tomography image calculated from a subject projection image in which a background is corrected using the method employed in the comparative example described above.

The sinogram and the tomographic image illustrated in FIG. 9A and FIG. 9B will be referred to later to discuss the effeteness of the reduction in artifact obtained in examples according to the embodiment described later.

Note that the sinogram is a diagram in which projection images are arranged in order of projection angles. In the sinogram, a horizontal axis indicates the position of the detector, and a vertical axis indicates the angle. Note that the phase tomography image refers to a two-dimensional distribution of a real part of a complex refraction index. In the present description, a projection image of a subject is acquired in a state in which an Eppendorf tube is inserted in a plastic container filled with water, and a reference projection image is acquired in a state in which the Eppendorf tube is off the field of view. Therefore, the phase tomography image represents a two-dimensional distribution of a difference from a real part of a complex refraction index of water.

### Second Comparative Example

In a second comparative example, to provide another comparative example for checking an effect of reducing artifact, background images Bₙ for use in background correction were acquired from the same reference projection images as those employed in the examples according to the embodiment described below. In this second comparative example, the background images Bₙ for use in background correction were calculated according to a formula described below.

$${B}_{n} = \{ \begin{matrix}{R}_{1} , & for 1 \leq n \leq 30 \\ {R}_{2} , & for 31 \leq n \leq 60 \\ {R}_{3} , & for 61 \leq n \leq 120 \\ {R}_{4} , & for 121 \leq n \leq 180 \\ {R}_{5} , & for 181 \leq n \leq 240 \\ {R}_{6} , & for 241 \leq n \leq 300 \\ {R}_{7} , & for 301 \leq n \leq 360\end{matrix}$$

That is, each phase projection image was acquired using a subject projection image and a reference projection image that was newest as of when the subject projection image was acquired.

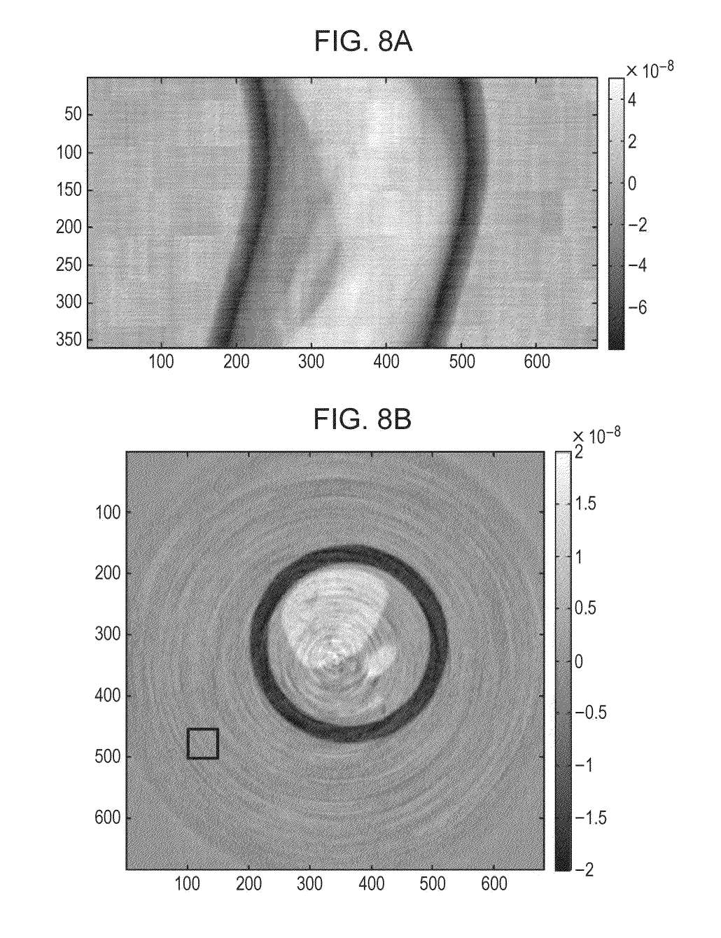

FIG. 8A and FIG. 8B respectively illustrate a sinogram and a phase tomography image calculated from a subject projection image obtained by performing the background correction using the method employed in the present comparative example.

### EXAMPLES

Next, examples according to the embodiment are described below.

### First Example

In a first example, a background image Bₙ for use in background correction of a subject projection image Sₙ was acquired from a reference projection image Rₘ according to a formula described below.

$${B}_{n} = \frac{1}{7} {\sum }_{m = 1}^{7} {R}_{m} , ( n = 1 , 2 , … , 360 )$$

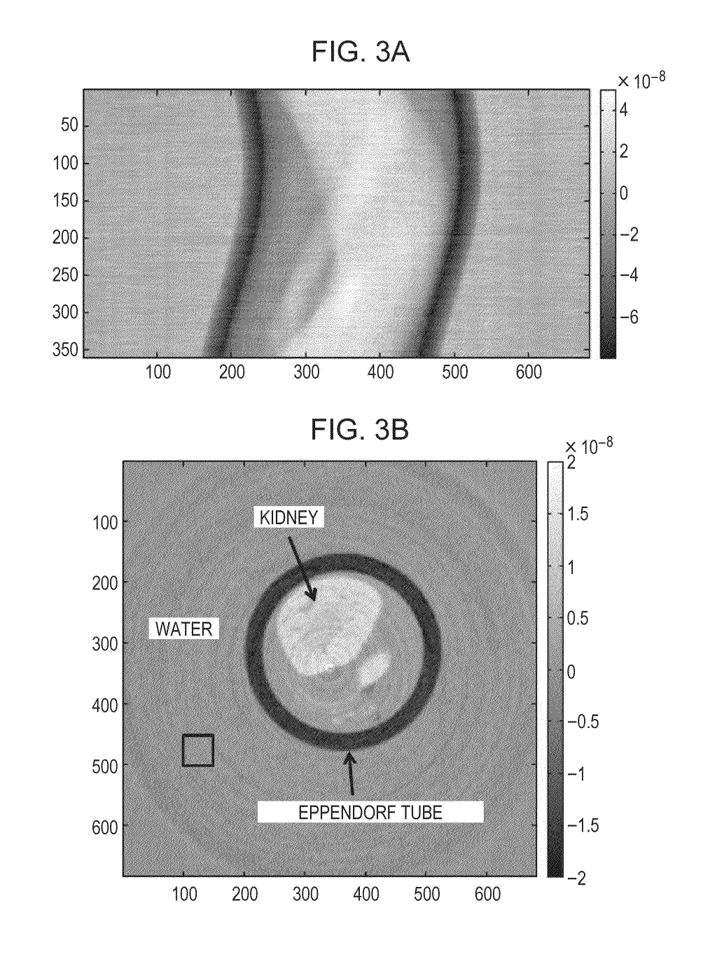

That is, the background image Bₙ was given by an average of all reference projection images, and thus the same background image was used in acquiring all phase projection images. FIG. 3A and FIG. 3B respectively illustrate a sinogram and a phase tomography image acquired from a subject projection image obtained by performing the background correction using the background image described above.

In the second comparative example described above, only one reference projection image was used as the background image, and thus the sinogram includes significant vertical line noise. In the present example, in contrast, because the background image was calculated from a plurality of reference projection images, statistical noise was suppressed and thus line noise in the sinogram was suppressed. As a result, an arc-like artifact was also reduced in the phase tomography image compared with the case where the conventional technique was used. Note that the obtained image quality of the phase tomography image was as good as nearly the image quality of the phase tomography image according to first comparative example shown in FIG. 9B.

A reference area denoted by a black frame line in the phase tomography image does not include information associated with the subject. Therefore, in this area, when the standard deviation is closer to 0, the artifact can be regarded as being smaller. In fact, in contrast to the second comparative example in which the standard deviation was 1.24×10⁻⁹, the standard deviation in the present example was 0.83×10⁻⁹.

### Second Example

In a second example, a background image Bₙ for use in background correction of a corresponding subject projection image Sₙ was acquired from a reference projection image according to a formula described below.

$${B}_{n} = {c}_{1} \times {R}_{1} + {c}_{2} \times {R}_{2} + {c}_{3} \times {R}_{3} + {c}_{4} \times {R}_{4} + {c}_{5} \times {R}_{5} + {c}_{6} \times {R}_{6} + {c}_{7} \times {R}_{7} , \\ ( {c}_{1} , {c}_{2} , {c}_{3} , {c}_{4} , {c}_{5} , {c}_{6} , {c}_{7} ) = \{ \begin{matrix}( 7 / 28 , 6 / 28 , 5 / 28 , 4 / 28 , 3 / 28 , 2 / 28 , 1 / 28 ) & for 1 \leq n \leq 30 \\ ( 6 / 33 , 7 / 33 , 6 / 33 , 5 / 33 , 4 / 33 , 3 / 33 , 2 / 33 ) & for 31 \leq n \leq 90 \\ ( 5 / 36 , 6 / 36 , 7 / 36 , 6 / 36 , 5 / 36 , 4 / 36 , 3 / 36 ) & for 91 \leq n \leq 150 \\ ( 4 / 37 , 5 / 37 , 6 / 37 , 7 / 37 , 6 / 37 , 5 / 37 , 4 / 37 ) & for 151 \leq n \leq 210 \\ ( 3 / 36 , 4 / 36 , 5 / 36 , 6 / 36 , 7 / 36 , 6 / 36 , 5 / 36 ) & for 211 \leq n \leq 270 \\ ( 2 / 33 , 3 / 33 , 4 / 33 , 5 / 33 , 6 / 33 , 7 / 33 , 6 / 33 ) & for 270 \leq n \leq 330 \\ ( 1 / 28 , 2 / 28 , 3 / 28 , 4 / 28 , 5 / 28 , 6 / 28 , 7 / 28 ) & for 331 \leq n \leq 360\end{matrix}$$

where cₘ (m=1, 2, . . . , 7) is a weighting factor. That is, the background image was given by a weighted average of reference projection images in which the weighting factor was determined depending on the time elapsed between a subject projection image of interest and a reference projection image. Although the second example is the same as the first example in that the background image is calculated using all reference projection images, but it is different in that the contribution to the background image is reduced as the elapsed time increases since the subject projection image of interest was taken.

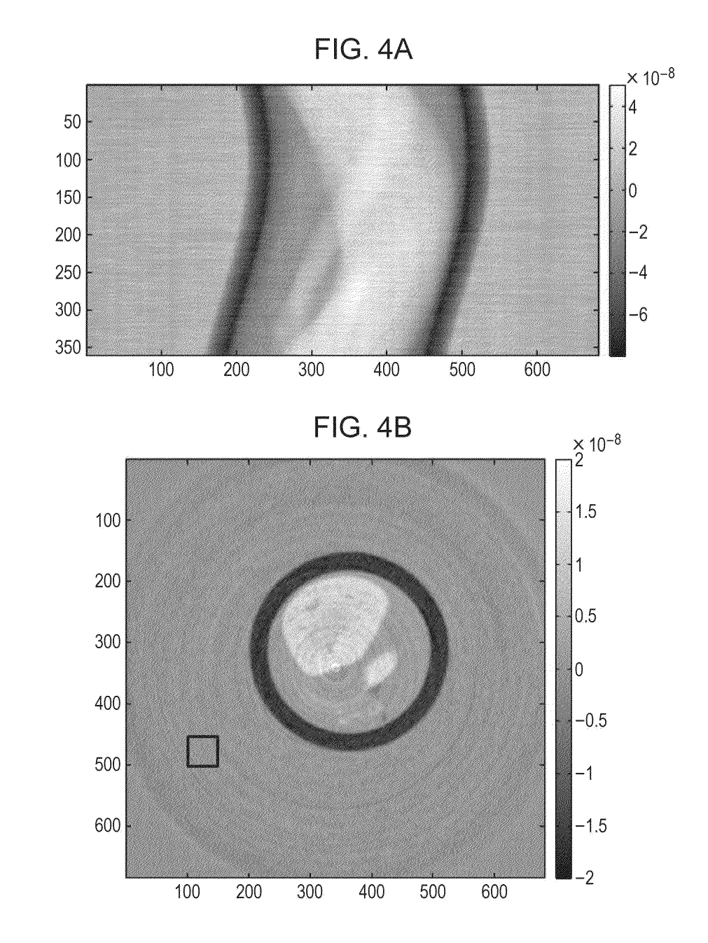

In a case where the background changes with passage of time, the method disclosed in the present example allows it to reduce the influence of the change. FIG. 4A and FIG. 4B respectively illustrate a sinogram and a phase tomography image calculated from a subject projection image obtained by performing the background correction using the background image described above.

The sinogram included lower line noise than that in the second comparative example, and thus an arc-like artifact in the tomographic image was reduced.

The standard deviation in a reference area denoted by a black frame line in the phase tomography image was 0.85×10⁻⁹. In the present example, there was little change in the background with passage of time compared with the statistical noise, and thus there was substantially no difference between the first and second examples. However, in a case where there is a large change in the background with passage of time, it is predicted to achieve a greater effect of reducing artifacts than achieved in the first example. In the case of the imaging apparatus using a grating such as a Talbot interferometer, a possible cause of a change in background is, for example, a movement of the grating.

### Third Example

In a third example, a background image Bₙ for use in background correction of a subject projection image Sₙ is acquired from a reference projection image according to a formula described below.

$${B}_{n} = {c}_{1} \times {R}_{1} + {c}_{2} \times {R}_{2} + {c}_{3} \times {R}_{3} + {c}_{4} \times {R}_{4} + {c}_{5} \times {R}_{5} + {c}_{6} \times {R}_{6} + {c}_{7} \times {R}_{7} , \\ ( {c}_{1} , {c}_{2} , {c}_{3} , {c}_{4} , {c}_{5} , {c}_{6} , {c}_{7} ) = \{ \begin{matrix}( 2 / 3 , 1 / 3 , 0 , 0 , 0 , 0 , 0 ) & for 1 \leq n \leq 30 \\ ( 1 / 4 , 2 / 4 , 1 / 4 , 0 , 0 , 0 , 0 ) & for 31 \leq n \leq 90 \\ ( 0 , 1 / 4 , 2 / 4 , 1 / 4 , 0 , 0 , 0 ) & for 91 \leq n \leq 150 \\ ( 0 , 0 , 1 / 4 , 2 / 4 , 1 / 4 , 0 , 0 ) & for 151 \leq n \leq 210 \\ ( 0 , 0 , 0 , 1 / 4 , 2 / 4 , 1 / 4 , 0 ) & for 211 \leq n \leq 270 \\ ( 0 , 0 , 0 , 0 , 1 / 4 , 2 / 4 , 1 / 4 ) & for 270 \leq n \leq 330 \\ ( 0 , 0 , 0 , 0 , 0 , 1 / 3 , 2 / 3 ) & for 331 \leq n \leq 360\end{matrix}$$

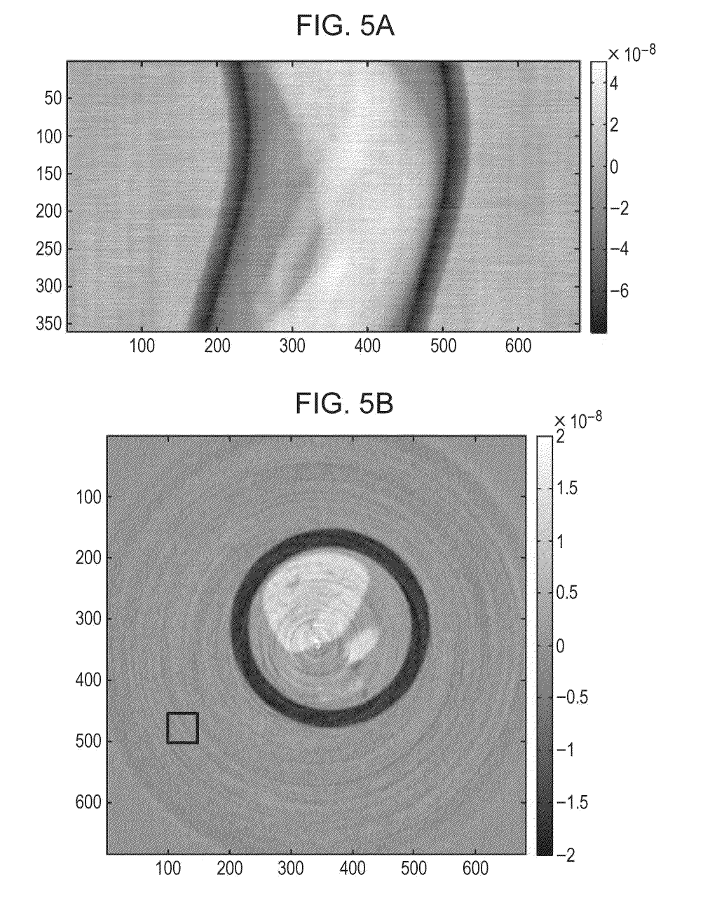

In the present example, a background image was acquired from two or three reference projection images taken short times after a subject projection image of interest was taken. In a case where the background changes greatly with passage of time, it is necessary to make a trade-off between the influence of a change in background and statistical noise, and the technique disclosed in the present example is effective to achieve a good trade-off. FIG. 5A and FIG. 5B respectively illustrate a sinogram and a phase tomography image calculated from a subject projection image obtained by performing the background correction using the background image described above.

The sinogram included lower line noise than that in the second comparative example, and thus an arc-like artifact in the tomographic image was reduced.

The standard deviation in a reference area denoted by a black frame line in the phase tomography image was 1.06×10⁻⁹. The standard deviation was slightly greater than those in the first and second embodiments because the change in background with passage of time in the present example was smaller than the statistical noise.

### Fourth Example

In a fourth embodiment, a background image Bₙ for use in background correction of a corresponding subject projection image Sₙ was acquired from a reference projection image according to a formula described below.

$${B}_{n} = {c}_{1} \times {R}_{1} + {c}_{2} \times {R}_{2} + {c}_{3} \times {R}_{3} + {c}_{4} \times {R}_{4} + {c}_{5} \times {R}_{5} + {c}_{6} \times {R}_{6} + {c}_{7} \times {R}_{7} , \\ ( {c}_{1} , {c}_{2} , {c}_{3} , {c}_{4} , {c}_{5} , {c}_{6} , {c}_{7} ) = \{ \begin{matrix}( ( 121 - 2 \times n ) / 120 , ( 2 \times n - 1 ) / 120 , 0 , 0 , 0 , 0 , 0 ) & for 1 \leq n \leq 60 \\ ( 0 , ( 241 - 2 \times n ) / 120 , ( 2 \times n - 121 ) / 120 , 0 , 0 , 0 , 0 ) & for 31 \leq n \leq 120 \\ ( 0 , 0 , ( 361 - 2 \times n ) / 120 , ( 2 \times n - 241 ) / 120 , 0 , 0 , 0 ) & for 121 \leq n \leq 180 \\ ( 0 , 0 , 0 , ( 481 - 2 \times n ) / 120 , ( 2 \times n - 361 ) / 120 , 0 , 0 ) & for 181 \leq n \leq 240 \\ ( 0 , 0 , 0 , 0 , ( 601 - 2 \times n ) / 120 , ( 2 \times n - 481 ) / 120 , 0 ) & for 241 \leq n \leq 300 \\ ( 0 , 0 , 0 , 0 , 0 , ( 721 - 2 \times n ) / 120 , ( 2 \times n - 601 ) / 120 ) & for 301 \leq n \leq 360\end{matrix}$$

In the present example, a background image was acquired from two reference projection images taken short times after a subject projection image of interest was taken. In the present example, the weighting factors were changed depending on n. Therefore, a combination of weighting factors employed was different depending on the subject projection image. More specifically, for example, a combination of weighting factors (119/120, 1/120, 0, 0, 0, 0, 0) was employed for B1 and a combination of weighting factors (61/120, 59/120, 0, 0, 0, 0, 0) which was different from that for B1 was employed for B30, although a combination of weighting factors (2/3, 1/3, 0, 0, 0, 0, 0) was equally employed for both B1 and B30 in the third example. A possible cause for line noise in sinograms is use of the same reference projection image in background correction for a plurality of successive subject projection images.

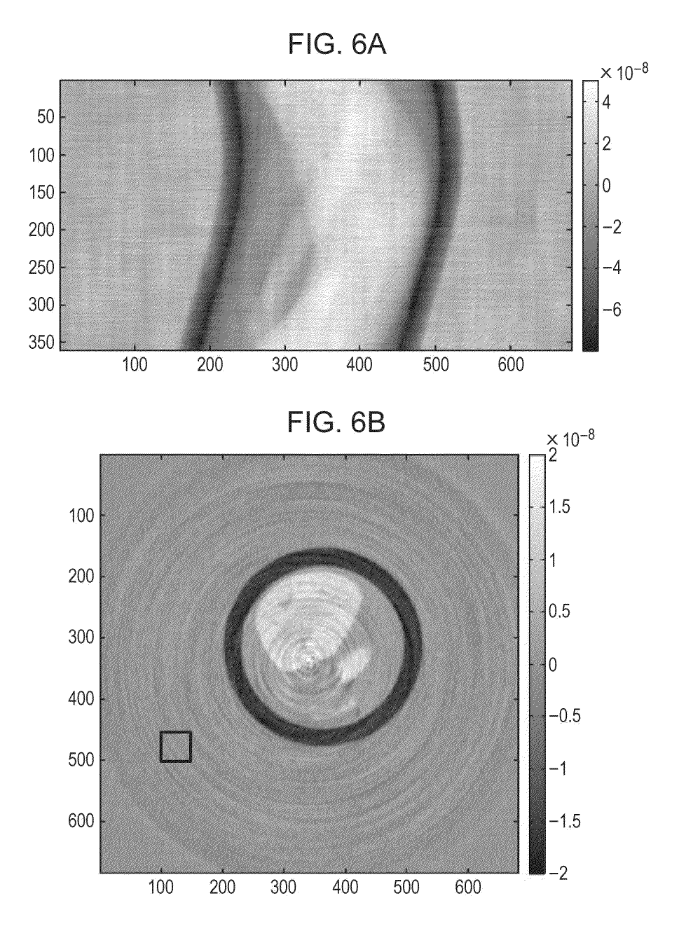

In the present example, the background correction for each subject projection image was performed using a background image specific for the subject projection image to reduce the effect described above. FIG. 6A and FIG. 6B respectively illustrate a sinogram and a phase tomography image acquired from a subject projection image obtained by performing the background correction using the background image described above.

The sinogram included lower line noise than that in the second comparative example, and thus an arc-like artifact in the tomographic image was reduced.

The standard deviation in a reference area denoted by a black frame line in the phase tomography image was 1.07×10⁻⁹.

### Fifth Example

In a fifth embodiment disclosed below, subject tomography images are acquired from background images acquired using different methods, and the subject tomography images are combined to obtain a new subject tomography image. In other words, a first projection image of subject information is acquired from a background image acquired using a first method, and a first tomographic image is acquired using the first projection image of subject information. Similarly, a second projection image of subject information is acquired from a background image acquired using a second method, and a second tomographic image is acquired using the second projection image of subject information. Note that the first method and the second method are different from each other (that is, background images are acquired using different methods). Using the first tomographic image and the second tomographic image, a new tomographic image (a third tomographic image) is acquired. Use of tomographic images acquired using different methods makes it possible to achieve effects similar to those acquired from different many reference images, and thus it becomes possible to achieve an improvement in the standard deviation in the reference area.

In the present example, the method employed in the third example was used as the first method, and the method employed in the fourth example was used as the second method. The tomographic image acquired in the third example was employed as the first tomographic image, and the tomographic image acquired in the fourth example was employed as the second tomographic image. An average of two phase tomography images, that is, the first and second phase tomography images was acquired to obtain the phase tomography image in the present example.

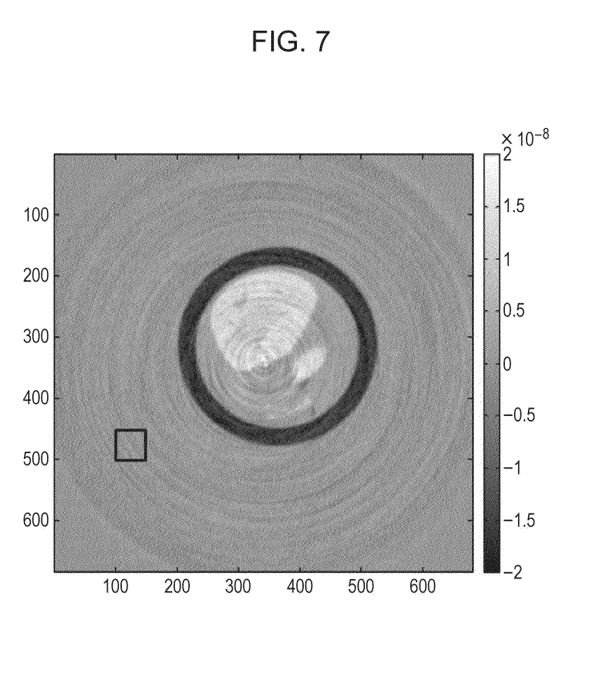

FIG. 7 is a diagram illustrating the acquired phase tomography image. The standard deviation in a reference area denoted by a black frame line in the phase tomography image was 1.05×10⁻⁹.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-263596, filed Dec. 20, 2013, which is hereby incorporated by reference herein in its entirety.

What is claimed is:

1. An X-ray tomography apparatus comprising:
a detector configured to detect a X-ray passing though a subject;
a moving unit configured to move at least one of the subject and the detector; and
an operation unit configured to acquire a tomographic image of the subject using a subject projection image detected by the detector in a state in which the subject is in a field of view of the detector and a plurality of reference projection images detected by the detector in a state in which the subject is not in the field of view of the detector,
the detector being configured to detect the subject projection image and the reference projection image at a plurality of projection angles,
the operation unit being configured to
acquire a background image using a plurality of reference projection images,
acquire a projection image of subject information using the subject projection image and the background image for each of the projection angles, and
acquire tomographic image of the subject information from the projection image of the subject information for each of the projection angles.

2. The X-ray tomography apparatus according to claim 1, wherein the operation unit employs an average of the reference projection images as the background image.

3. The X-ray tomography apparatus according to claim 1, wherein the operation unit acquires the background image by weighting a contribution of each of the reference projection images to the background image.

4. The X-ray tomography apparatus according to claim 3, wherein the operation unit weights the contribution of each reference projection image in the plurality of reference projection images depending on a time elapsed from the taking of the subject projection image to the taking of the reference projection image of interest.

5. The X-ray tomography apparatus according to claim 2, wherein the operation unit acquires a plurality of background images and employs a different background image, depending on the projection angle, in acquiring the projection image of the subject information.

6. The X-ray tomography apparatus according to claim 2, wherein a combination of contributions is different depending on the projection angle.

7. The X-ray tomography apparatus according to claim 1, wherein the operation unit acquires a first tomographic image, a second tomographic image, and a third tomographic image such that the first tomographic image is acquired from a projection image of first subject information acquired using a background image acquired using a first method, the second tomographic image is acquired from a projection image of second subject information acquired using a background image acquired using a second method different from the first method, and the third tomographic image is acquired from the first tomographic image and the second tomographic image.

8. An X-ray tomography image acquisition method comprising:
acquiring a tomographic image using subject projection images detected at a plurality of projection angles by a detector in a state in which the subject is in a field of view of the detector and a plurality of reference projection images detected by the detector in a state in which the subject is not in the field of view of the detector;
acquiring a projection image of subject information using a subject projection image and the background image for each of the projection angles; and
acquiring a tomographic image from the projection image of the subject information for each of the projection angles.
